(19) United States
(12) Patent Application Publication
(10) Pub. No.: US 2008/0191875 A1
(43) Pub. Date: Aug. 14, 2008

(54) Radio frequency identification system using piezoelectric body

(76) Inventor: Soon Pil Park, Gyeongsangnam-do (KR)

Correspondence Address: BIRCH STEWART KOLASCH & BIRCH, PO BOX 747, FALLS CHURCH, VA, 22040-0747, US

(21) Appl. No.: 11/704,191

(22) Filed: Feb. 9, 2007

(51) Int. Cl. G08B 23/00

(52) U.S. Cl. 340/572.1

(57) ABSTRACT

Provided is an RFID system using a piezoelectric body. The RFID system includes the piezoelectric body, a tag, a reader, and a host. The piezoelectric body producing power using external pressure, and the tag is connected to the piezoelectric body, records data, and transmits an RF signal when power is supplied from the piezoelectric body. The reader deciphers data contained in the RF signal received from the tag, and the host processes data deciphered at the reader. The piezoelectric body is mounted on a portion of an object to which external pressure is applied.

### BACKGROUND OF THE INVENTION

1. Field of the Invention

The present invention relates to a radio frequency identification (RFID) system, and more particularly, to an RFID system using a piezoelectric body, for simultaneously providing a power supplying function and a switching function to the RFID system using an operation characteristic of a piezoelectric body by forming a power source of a tag for transmitting data using a piezoelectric body.

2. Description of the Related Art

Generally, RFID is technology for attaching an electronic tag to all objects and detecting data of the objects and data of an environment status of the objects using wireless communication technology.

An RFID system attaches a tag to all needed things (places), detects basic identification data of an object through the tag, detects even environment (e.g., temperature, humidity, contamination data, and crack data) in the case where the RFID system is combined with sensing technology, and connects to a network in real-time to manage received data.

A related art active RFID device includes an antenna, a reader, a host, an active tag, and a power unit of the active tag.

As described above, the active tag includes the power unit separately in order to receive power. The power unit includes a battery or rechargeable battery to supply power.

However, the related art RFID device has the following problems.

In the related art active RFID device having the above-described construction, the battery or rechargeable battery used for a power source of the active tag has a limited life.

When power is applied, the active tag of the active RFID device transmits data constantly unless power is manually cut off or a separate program for cutting off power is added, so that power is consumed unnecessarily.

Also, since the related art active tag does not stop an operation of the active tag unless power is manually cut off or a separate program is provided to cut off power, using the active tag is limited.

### SUMMARY OF THE INVENTION

Accordingly, the present invention is directed to an RFID system using a piezoelectric body that substantially obviates one or more problems due to limitations and disadvantages of the related art.

An object of the present invention is to provide an RFID system using a piezoelectric body, for simultaneously providing a power supplying function and a switching function to the RFID system using an operation characteristic of a piezoelectric body by forming a power source of a tag for transmitting data using a piezoelectric body.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an RFID (radio frequency identification) system using a piezoelectric body, the system including: a piezoelectric body for producing power using external pressure; a tag connected to the piezoelectric body, recording data, and transmitting an RF signal when power is supplied from the piezoelectric body; a reader for deciphering data contained in the RF signal received from the tag; and a host for processing the data deciphered by the reader, wherein the piezoelectric body is mounted on a portion of an object to which external pressure is applied.

In another aspect of the present invention, there is provided an RFID system using a piezoelectric body, the system including: a tag for storing and transmitting data, and including a tag antenna for transmitting/receiving an RF signal, an IC chip for storing data and performing a control operation, and a piezoelectric body mounted on a portion of an object to which external pressure is applied; a reader for deciphering data contained in the RF data received from the tag; and a host for processing the data deciphered by the reader.

In further another aspect of the present invention, there is provided an RFID system using a piezoelectric body, the system including: a piezoelectric body for producing power using external pressure; a tag connected to the piezoelectric body, and transmitting an RF signal when power is supplied from the piezoelectric body; a reader for deciphering data contained in the RF signal received from the tag; and a host for processing the data deciphered by the reader, wherein the piezoelectric body is provided on a bottom surface of a building to produce power using pressure applied due to weight of a human body.

The above-described RFID system using the piezoelectric body according to the present invention uses the piezoelectric body as a power source. Therefore, since the RFID system using the piezoelectric body as a power source has the power source having a semi-permanent life, life of the power source of the RFID system improves.

Also, as life of the power source improves, maintenance costs of the RFID system using the piezoelectric body are reduced.

Also, since the piezoelectric body is used as a power source, a power supplying function and a switching function using a structural characteristic of the piezoelectric body can be simultaneously realized.

Furthermore, since a power supplying function and a switching function of the RFID system using the piezoelectric body can be simultaneously realized, utilization of the RFID system is maximized.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram of an RFID system using a piezoelectric body according to the present invention;

FIG. 2 is a conceptual view illustrating power generating principle of a piezoelectric body, which is a crucial element of an RFID system using a piezoelectric body according to the present invention;

FIG. 3 is a schematic block diagram illustrating a system of checking security of old people living alone to which an RFID system using a piezoelectric body according to an embodiment of the present invention is adopted; and

FIG. 4 is a flowchart illustrating a flow of a control signal in the system of checking security of old people living alone illustrated in FIG. 3.

### DETAILED DESCRIPTION OF THE INVENTION

Reference will now be made in detail to the preferred embodiments of the present invention, examples of which are illustrated in the accompanying drawings.

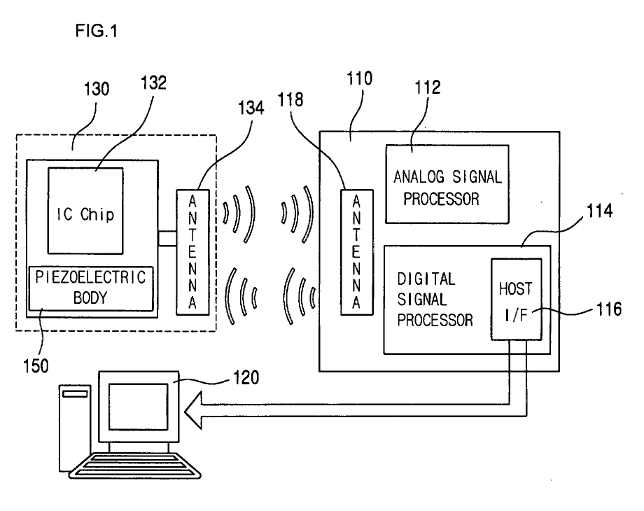

FIG. 1 is a schematic block diagram of an RFID system using a piezoelectric body according to the present invention.

Referring to FIG. 1, the RFID system includes a tag 130, a reader 110, and a host 120.

The tag 130 is responsible for storing and transmitting data, and includes a tag antenna 134 for transmitting/receiving an RF data, an IC chip 132 for storing and controlling data, and a piezoelectric body 150 for generating power.

The tag antenna 134 is provided in one side of the tag 130 to transmit and receive data to and from the reader 110 using RF signals. The tag antenna 134 has various shapes depending on its purpose.

The RF signals have a radiation frequency of less than 1 giga Hz to enable long distance transmission.

The IC chip 132 is provided with power from the piezoelectric body 150 to store data and control a transmission/reception circuit. The IC chip 132 is provided inside the tag 130.

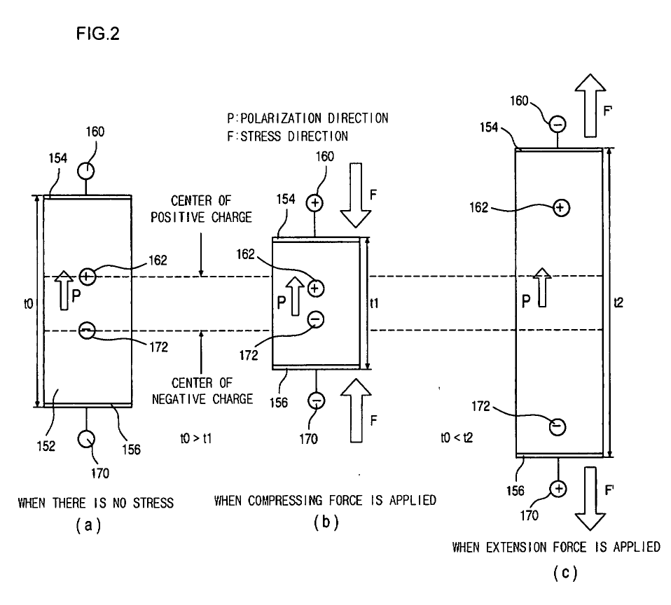

FIG. 2 is a conceptual view illustrating power generating principle of a piezoelectric body, which is a crucial element of an RFID system using a piezoelectric body according to the present invention.

Referring to FIG. 2, the piezoelectric body 150 is mounted on one side of the IC chip 132 to apply power required for an operation of the system. The piezoelectric body 150 is formed in a 3-dimensional structure having a predetermined thickness.

Also, the piezoelectric body 150 is filled with a piezoelectric material 152 for generating power. Polar plates 154 and 156 formed of an approximately thin film shaped conductor are provided on both sides of the piezoelectric body 150, respectively. Terminals 160 and 170 are mounted on sides of both the polar plates 154 and 156, respectively.

Both the polar plates 160 and 170 are formed of metal having excellent conductivity to emit a current generated by the piezoelectric body 150.

Referring to FIG. 2A, when no external stress is applied to the piezoelectric body 150, a positive charge 162 and a negative charge 172 are stably located inside the piezoelectric material 152, so that a state having anisotropy and no flowing of charge is maintained.

Referring to FIG. 2B, when compressing force F is applied to the piezoelectric body 150 having no flowing of charge, the thickness of the piezoelectric body 150 reduces from t0 to t1.

When the piezoelectric body 150 changes into this state, the area of the piezoelectric material 152 reduces and an internal space narrows, so that charges move actively. Also, the charges are divided into positive charges 162 and negative charges 172 and collected on both the polar plates 154 and 156 located on the upper and lower surfaces of the piezoelectric body 150, respectively.

The above-divided positive charges 162 are collected on the upper polar plate 154 to form a positive polar plate, i.e., a plus (+) electrode. The negative charges 172 are collected on the lower polar plate 156 to form a minus (−) electrode. Therefore, a potential difference is generated between the polar plates 154 and 156 to generate a voltage.

On the other hand, when extension force F′ is applied as illustrated in FIG. 2C, the thickness of the piezoelectric body 150 increases from t0 to t2.

When the piezoelectric body 150 changes into this state, the area of the piezoelectric material 152 increases and a space where the charges moves extends, so that constraining force between atoms of the piezoelectric material becomes weak. The charges having weakened constraining force move actively and are divided into positive charges 162 and negative charges 172, and collected to the polar plates 154 and 156 located on the upper and lower surfaces of the piezoelectric body 150, respectively.

The divided positive charges 162 are collected on the lower polar plate 156 to form a plus (+) electrode. The negative charges 172 are collected on the upper polar plate 154 to form a minus (−) electrode. Therefore, a potential is generated between the polar plates 154 and 156 to generate a voltage.

The above-generated voltage can be utilized as a power source. This power source is connected to the terminals 160 and 170 of the polar plates 154 and 156 and applied to the tag 130, so that the piezoelectric body 150 is used as a power source of the tag 130. Also, preferably, a rectifying circuit and/or a transforming circuit (not shown) is mounted for more stabler power supply.

A user can realize a switching function through an RFID system using a piezoelectric body as a power source by applying the above-described power generating principle.

That is, when a tag using the piezoelectric body as a power source is attached to a portion to which pressure is applied, power is supplied to the tag via the piezoelectric body when pressure is applied to that portion, and the tag serves as a switch for transmitting a signal to an operating circuit.

Also, when a tag using the piezoelectric body as a power source is attached to a portion to which extension is applied, power is supplied to the tag via the piezoelectric body when extension is applied to that portion, and the tag serves as a switch for transmitting a signal to an operating circuit.

Referring to FIG. 1, the reader 110 includes a reader antenna 118, an analog signal processor 112, a digital signal processor 114, and a host interface 116 to decipher received data from the tag and control transmission of a frequency.

Like the tag antenna 134, the reader antenna 118 is provided in one side of the reader 110 to transmit and receive data using RF signals. The reader antenna 118 has various shapes depending on its purpose.

The analog signal processor 112 is provided inside the reader 110, and, though not shown, includes a low noise amplifier (LNA) for lowering received noises and a demodulator for recovering a modulated signal back to an original signal.

The digital signal processor 114 is provided inside the reader 110, and includes a host interface 116, and though not shown, a reference clock generator for generating a reference clock to set a transmission/reception reference speed, a decoder for converting a digital signal into an analog signal, and a digital processor for arithmetically/logically operating data.

The host 120 can be a computer or an external device for processing data received from the reader 110. Also, the host 120 processes and stores a data signal received from the reader 110, and can transmit data to the reader 110 when needed. Also, an agent-based distributed network system can be provided in order to process a large amount of data received from a plurality of readers.

A system for of checking security of old people living alone to which an RFID system using a piezoelectric body according to an embodiment of the present invention is adopted will be described below with reference to the accompanying drawings.

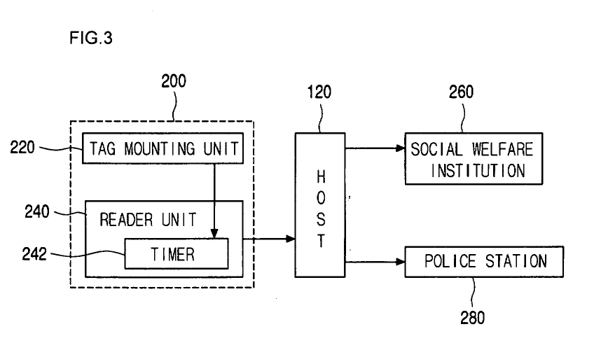

FIG. 3 is a schematic block diagram illustrating a system of checking security of old people living alone to which an RFID system using a piezoelectric body according to an embodiment of the present invention is adopted.

Referring to FIG. 3, the system of checking security of old people living alone includes a tag mounting unit 220 mounted inside a house 200 of the old people living alone, a reader unit 240 for transmitting data recorded on the tag mounting unit 220 to the host 120, and a host 120 for receiving data transmitted from the reader unit 240 and informing the received data to a social welfare institution 260 and/or a police station 280.

In more detail, the tag mounting unit 220 mounted inside the house 200 of the old people living alone is formed a bottom surface neighboring a bathroom or a front door.

That is, the tag mounting unit 220 includes an RFID tag 130 (of FIG. 1) that uses the piezoelectric body as a power source, and a pressurizing plate (not shown) provided on an upper side of the tag 130. A size of the pressurizing plate (not shown) may be controlled so that old people living alone can easily step and press the pressurizing plate when entering a bathroom or a front door.

Also, as pressure is applied to the pressurizing plate, power generated by the piezoelectric body 150 (of FIG. 1) is supplied to the RFID tag 130 and data recorded on the IC chip 132 (of FIG. 1) is transmitted to the reader unit 240. That is, when a person steps on the pressurizing plate, pressure is applied to the piezoelectric body 150 provided on a lower surface of the pressurizing plate by weight of the person, and the piezoelectric body 150 generates power. When the power generated by the piezoelectric body 150 is supplied to the RFID tag 130, the RFID tag 130 transmits data to the reader 110 (of FIG. 1) provided to the reader unit 240.

Also, the IC chip 132 contains various data such as location of old people's house, personal data of the old people, and medical history. The IC chip 132 also contains a signal for resetting an operating circuit of a timer 242.

The reader unit 240 includes a reader 110 (of FIG. 1) for receiving data transmitted from the tag 130 (of FIG. 1) and transmitting the received data to the host 120, a bracket (not shown) to which the reader 110 is mounted, and a timer 242 for setting a predetermine time. The reader unit 240 is provided on one side of the house 200 of the old people living alone.

Also, the reader 110 transmits data of the old people living alone received from the tag 130 to the host 120 in the case where a signal is not transmitted from the tag 130 for a predetermined time set by the timer 242. A signal received from the tag 130 for the set predetermined time resets the timer 242.

Meanwhile, data transmitted from the reader unit 240 is transmitted to the host 120. The transmitted data is retransmitted to a social welfare institution 260 and/or a neighboring police station 280 associated with the old people living alone. At this point, the retransmitted data contains a signal informing that the old people living alone is in an emergency situation.

That is, the above-described situation means that the old people living alone does not enter or exit a bathroom or a front door for the set predetermined time of the timer 242. In this case, there is a possibility that a problem has been generated to the condition of the old people living alone, which is formed of to the social welfare institution 260 or the neighboring police station 280.

Meanwhile, the host 120 may be an agent-based distributed network system for processing a large amount of data.

A flow of a control signal in a system for checking security of old people living alone having the above-described construction according to an embodiment of the present invention will be described with reference to the accompanying drawings.

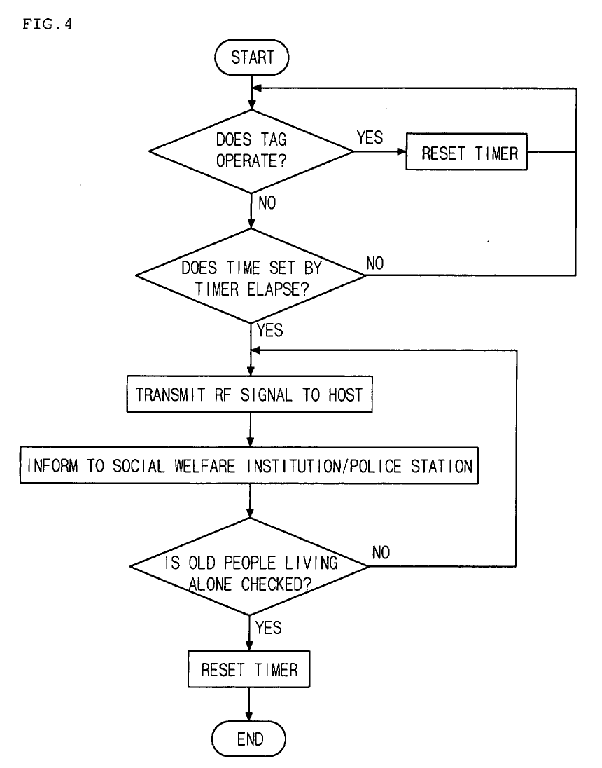

FIG. 4 is a flowchart illustrating a flow of a control signal in the system of checking security of old people living alone illustrated in FIG. 3. Referring to FIG. 4, when pressure is applied to the tag mounting unit 220 by behavior of the old people living alone, the tag 130 operates.

When the tag 130 operates, the tag 130 transmits a reset signal to the timer 242 to reset the timer 242 whenever the tag mounting unit 220 is pressurized.

On the other hand, when a signal is not received in the reader 110 for a predetermined time set by the timer 242, the reader 110 transmits a radio signal to the host 120.

That is, since a behavior range of the old people living alone does not reach the tag mounting unit 220 as described above, a transmitted radio signal contains contents warning that a problem has been generated to the old people living alone as well as personal data, a residential address, and medical history of the old people living alone stored in the tag 130.

When a radio signal is transmitted to the host 120, the host 120 informs the social welfare institution 260 responsible for the old people living alone and/or the police station 280 in the neighborhood of a residential area of the old people living alone that a problem has been generated to the old people living alone on the basis of data contained in the received radio signal, that is, personal data of the old people living alone.

When a fact that a problem has been generated to the old people living alone is informed of to the old people living alone is received, the social welfare institution 260 responsible for the old people living alone and/or the police station 280 sends a personnel to the house of the old people living alone, checks a state of the old people living alone, takes an appropriate measure, and resets the timer 242 provided to the reader unit 240.

An operation of an RFID system using a piezoelectric body according to the present invention making the above-described embodiment possible will be described below in detail.

When receiving an RF signal from the reader 110, the tag 130 sends the received RF signal to the IC chip 132 of the tag 130 connected to two terminals of the tag antenna 134.

The signal received at this time is an analog signal containing disturbance. Since the disturbance can be a reason of generating an error while data is processed, the disturbance should be removed. For this reason, the disturbance is removed using a radio frequency filter (RFF), though not shown, and the analog signal is modulated into a digital signal.

The above-modulated signal passes through an internal processing procedure and passes through a demodulating process for transmission. The modulating process makes processing data easy, and the demodulating process makes long distance communication easy. The modulating/demodulating processes are performed in an internal circuit of the IC chip 132.

The IC chip 132 receives power from the piezoelectric body 150, reproduces a reference clock from a unique carrier frequency signal received from the tag antenna 134, modulates delivered transmission signal, and transmits the modulated signal to the reader 110.

The reader 110 amplifies a weak signal through an LNA provided inside the analog signal processor 112. The analog signal processor 112 performs amplitude-shift-keying (ASK) on a signal transmitted from the tag antenna 134, and transmits the signal to the digital signal processor 114.

The ASK conveys data on the amplitude of a sine wave used as a carrier. The amplitude-shift-keyed signal contains data included in the tag 130.

The analog signal processor 112 demodulates the amplitude-shift-keyed signal and transmits the demodulated signal to a decoder (not shown) of the digital signal processor 114.

The decoder of the digital signal processor 114 performs sampling on received signals and stores a sampled value as data. That is, the decoder identifies a ‘start of frame (SOF)’ informing a start of one frame from the stored and received signal, generates a data start detecting signal informing the SOF, and simultaneously, stores the data start detecting signal in an internal register to allow a processor (not shown) to know the SOF.

Also, the decoder identifies an ‘end of frame (EOF)’ informing an end of one frame from the stored and received signal, generates a data end detecting signal informing the EOF, and simultaneously, stores the data end detecting signal in the internal register to allow the processor (not shown) to know the EOF.

A signal demodulated at the reader 110 is delivered to the host interface 116. The host interface 116 collects data that have passed through a series of processing procedures at the reader 110 and transmits/receives the data to the host 120.

The data collected to the host 120 are classified and stored, and transmitted to the reader 110 requesting data.

The RFID system using the piezoelectric body operating in the above-described manner can be utilized in a variety of fields besides the above-described system of checking the security of the old people living alone.

For example, the RFID system using the piezoelectric body according to the present invention can be applied to a system for preventing a domestic animal and a pet from being lost, and a crime prevention system.

In the system for preventing the domestic animal and the pet from being lost, an RFID tag using the piezoelectric body as a power source is embedded in the sole of a foot of the domestic animal or the pet, and a position of the domestic animal or the pet is traced, so that losing the domestic animal or the pet is prevented. Also, since whether the domestic animal or the pet moves can be checked in real-time, an amount of movements of the domestic animal or the pet can be measured, and data management for breeding can be made.

Unlike the system for preventing the domestic animal and the pet from being lost, the crime prevention system uses power generated when extension force is applied to the piezoelectric body.

When the tag is mounted on a door, a window, or a show window of a building, and an entrance is opened by a stranger, the tag fixedly mounted on one side of the window or the show window performs a switching function to transmit an unauthorized access signal. The transmitted signal is delivered to a neighboring police station via a network.

Examples of the present invention applicable to an industrial system include an overspeeding vehicle measuring system, an automated machine equipment system, a disaster/rescue signal transmitting system, and a physical distribution managing system.

In the overspeeding vehicle measuring system, an RFID tag using the piezoelectric body as a power source is mounted on one side of a tire of a vehicle. The RFID tag transmits data of one time when the tire rotates one time. Accordingly, it is possible to calculate a revolution per minute (RPM) of the tire by collecting data received when the tire rotates one time for one minute. Establishing a system using a reader for detecting an RPM and a host makes it possible to realize a more accurate overspeeding vehicle measuring system.

The automated machine equipment system can utilize the tag of the RFID system using the piezoelectric body as a power source as a stopper for stopping a product. Also, the tag of the RFID system can be mounted on a contact portion of a product and utilized as a wireless sensor of an automated machine.

In the disaster/rescue signal transmitting system, the tag of the RFID system using the piezoelectric body as a power source is mounted on one side of an engine of an airplane or a ship to detect vibration of the engine, so that whether the engine operates or a status of the engine is checked. When emergency stopping occurs, an SOS signal is automatically transmitted.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An RFID (radio frequency identification) system using a piezoelectric body, the system comprising:
a piezoelectric body for producing power using external pressure;
a tag connected to the piezoelectric body, for recording data, and transmitting an RF signal when power is supplied from the piezoelectric body;
a reader for deciphering data contained in the RF signal received from the tag; and
a host for processing the data deciphered by the reader, wherein the piezoelectric body is mounted on a portion of an object to which external pressure is applied.

2. The system according to claim 1, wherein the piezoelectric body is mounted in one side of the tag.

3. The system according to claim 2, wherein the tag comprises:
a tag antenna for illuminating an RF signal to transmit the recorded data to the reader; and
an IC (integrated circuit) chip for controlling communication with the reader and storing data.

4. The system according to claim 1, wherein the reader comprises:
a reader antenna for transmitting/receiving RF signals;
an analog signal processor for modulating signals transmitted from the reader antenna; and
a digital signal processor for analyzing signals received from the analog signal processor and delivering the analyzed signals to the host.

5. The system according to claim 1, wherein the host comprises one of a computer and a portable terminal for processing data.

6. An RFID system using a piezoelectric body, the system comprising:
a tag for storing and transmitting data, and including a tag antenna for transmitting/receiving an RF signal, an IC chip for storing data and performing a control operation, and a piezoelectric body mounted on a portion of an object to which external pressure is applied;
a reader for deciphering data contained in the RF signal received from the tag; and
a host for processing the data deciphered by the reader.

7. The system according to claim 6, wherein the reader comprises:
a reader antenna for transmitting/receiving RF signals;
an analog signal processor for modulating signals transmitted from the reader antenna; and
a digital signal processor for analyzing signals received from the analog signal processor and delivering the analyzed signals to the host.

8. An RFID system using a piezoelectric body, the system comprising:
a piezoelectric body for producing power using external pressure;
a tag connected to the piezoelectric body, and transmitting an RF signal when power is supplied from the piezoelectric body;
a reader for deciphering data contained in the RF signal received from the tag; and
a host for processing the data deciphered by the reader,
wherein the piezoelectric body is provided on a bottom surface of a building to produce power using pressure applied due to weight of a human body.

9. The system according to claim 8, wherein the tag comprises:
a tag antenna for illuminating an RF signal to transmit recorded data to the reader; and
an IC chip for controlling communication with the reader and storing data,
wherein the IC chip stores personal data of a predetermined person and data regarding a location of house of the predetermined person.

10. The system according to claim 9, wherein the reader transmits data regarding the predetermined person to the host when there is no signal transmitted from the tag for a set predetermined time.

11. The system according to claim 10, wherein the host retransmits data received from the reader to other institution.

12. The system according to claim 11, wherein the other institution receiving the data transmitted from the host comprises one of a social welfare institution and a police station.
